(19) United States
(12) Patent Application Publication
(10) Pub. No.: US 2026/0203195 A1
(43) Pub. Date: Jul. 16, 2026

(54) TESTING OF SOFTWARE DEPLOYMENT PIPELINES USING PRIORITIZED TEST CASES

(71) Applicant: Dell Products L.P., Round Rock, TX (US)

(72) Inventors: Igor Dubrovsky, Beer Sheva (IL); Boris Shpilyuck, Ashdod (IL); Nisan Haimov, Beer Sheva (IL)

(21) Appl. No.: 19/022,219

(22) Filed: Jan. 15, 2025

(51) Int. Cl. G06F 11/3668

(52) U.S. Cl. CPC G06F 11/3672

(57) ABSTRACT

Techniques are provided for testing of software deployment pipelines using prioritized test cases. One method comprises obtaining a request to merge software code changes associated with software code; performing the following steps, in response to the at least one request: performing a static code analysis to identify changed portions of the software code associated with the software code changes; obtaining a mapping of each of the identified changed portions to corresponding test cases to execute to evaluate the software code changes; obtaining a classification of each mapped test case into a respective one of a plurality of priority categories; and executing the mapped test cases in a first priority category to obtain a first set of test results; and automatically initiating processing steps based on the first set of test results.

### BACKGROUND

A software deployment pipeline automates a software delivery process, and typically comprises a set of automated processes and tools that allow software developers and an operations team to work together to generate and deploy application software code to a production environment using a software development platform. Software development tasks often employ a software build process to compile the generated software code.

### SUMMARY

Illustrative embodiments of the disclosure provide techniques for testing of software deployment pipelines using prioritized test cases. One method includes obtaining at least one request to merge one or more software code changes associated with a first branch of software code of a software deployment pipeline with a second branch of software code of the software deployment pipeline; performing the following steps, in response to the at least one request: performing a static code analysis to identify one or more changed portions of the software code associated with the one or more software code changes; obtaining a mapping of each of the identified changed portions of the software code to one or more corresponding test cases to execute to evaluate the one or more software code changes; obtaining a classification of each of the mapped test cases into a respective one of a plurality of priority categories; executing the mapped test cases in a first priority category to obtain a first set of test results; and automatically initiating one or more processing steps based at least in part on the first set of test results.

Illustrative embodiments can provide significant advantages relative to conventional techniques. For example, technical problems related to such conventional techniques are mitigated in one or more embodiments by automatically executing a set of prioritized test cases to evaluate an impact of one or more software file modifications.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for testing of software deployment pipelines using prioritized test cases in an illustrative embodiment;

FIG. 2A shows an example of a software development lifecycle in an illustrative embodiment;

FIG. 2B shows an example of one or more pipeline jobs in various stages of a software deployment pipeline in an illustrative embodiment;

FIG. 3 illustrates a software development system configured for testing of software deployment pipelines using prioritized test cases in an illustrative embodiment;

FIGS. 4 and 5 are flow charts illustrating exemplary implementations of processes for testing of software deployment pipelines using prioritized test cases in illustrative embodiments;

FIG. 6 illustrates an exemplary processing platform that may be used to implement at least a portion of one or more embodiments of the disclosure comprising a cloud infrastructure; and

FIG. 7 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for testing of software deployment pipelines using prioritized test cases.

The term DevOps generally refers to a set of practices that combines software development and information technology (IT) operations. DevOps are increasingly being used to shorten the software development lifecycle and to provide continuous integration, continuous delivery, and continuous deployment. Continuous integration (CI) generally allows development teams to merge and verify changes more often by automating software generation (e.g., converting source code files into standalone software components that can be executed on a computing device) and software tests, so that errors can be detected and resolved early. Continuous delivery extends continuous integration and includes efficiently and safely deploying the changes into testing and production environments. Continuous deployment (CD) allows code changes that pass an automated testing phase to be automatically released into the production environment, thus making the changes visible to end users. Such processes are typically executed within a software generation and deployment pipeline.

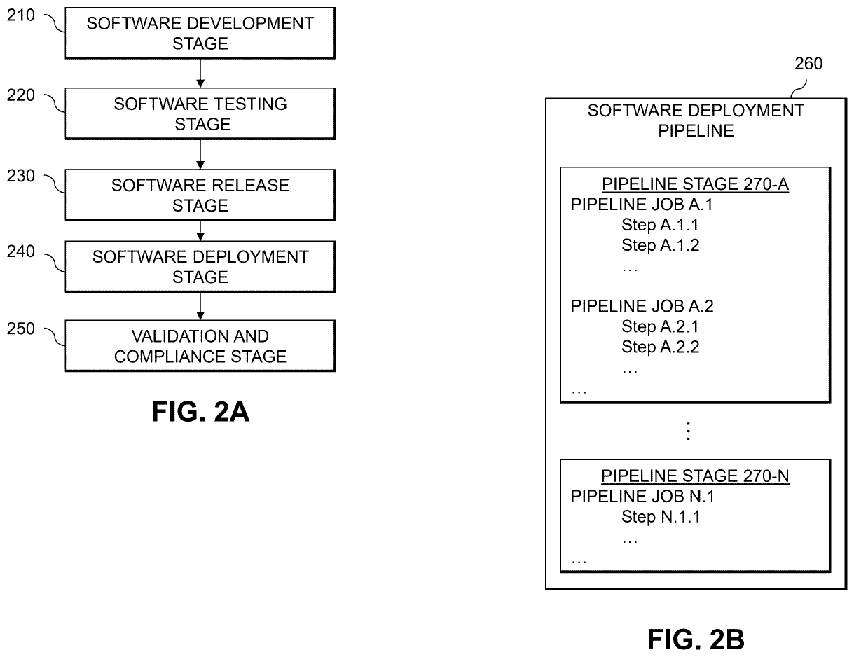

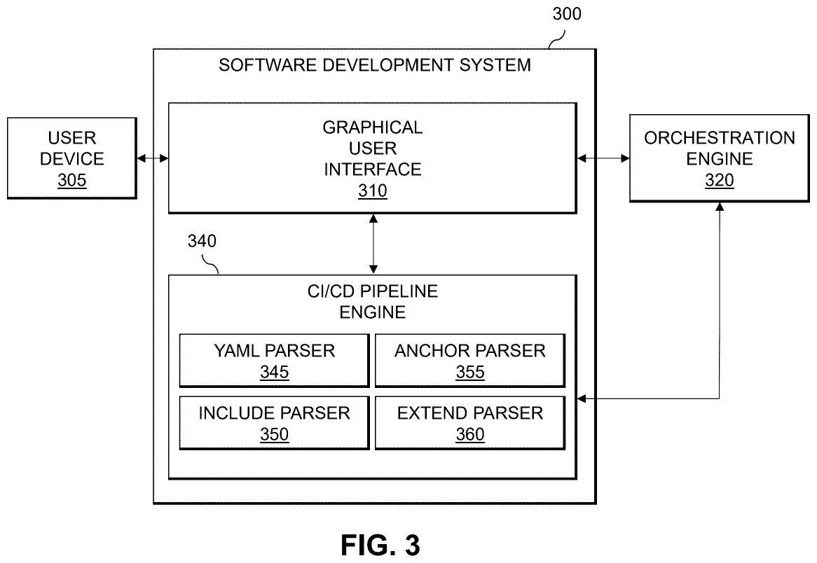

DevOps solutions typically employ blueprints that encompass continuous integration, continuous testing (CT), continuous deployment (also referred to as continuous development) and/or continuous change and management (CCM) abilities. DevOps blueprints allow development teams to efficiently innovate by automating workflows for a software development and delivery lifecycle. A typical software development lifecycle is discussed further below in conjunction with FIG. 2A.

A software deployment pipeline (sometimes referred to as a CI/CD pipeline) automates a software delivery process, and typically comprises a set of automated processes and tools that allow developers and an operations team to work together to generate and deploy application software code to a production environment. A preconfigured software deployment pipeline may comprise a specified set of elements and/or environments. Such elements and/or environments may be added or removed from the software deployment pipeline, for example, based at least in part on the software and/or compliance requirements. A software deployment pipeline typically comprises one or more quality control gates to ensure that software code does not get released to a production environment without satisfying a number of predefined testing and/or quality requirements. For example, a quality control gate may specify that software code should compile without errors or failures and that all unit tests and functional user interface tests must pass.

A common challenge faced by many software development teams is the time-consuming nature of running exhaustive test suites for software code changes, which may lead to delayed feedback and longer development cycles. A software product that is dealing with frequent software code updates, for example, may face significant delays in its deployment cycles. Each software code change may trigger a full suite of software tests, often resulting in a long wait time for software developers. Such a bottleneck may slow down the release of new software features and also increase the risk of integration issues, as software developers often have to wait for the test results before moving forward with their tasks. The prolonged feedback loop slows down the ability of software developers to respond quickly to market demands and to fix important bugs in a timely manner.

In one or more embodiments, the disclosed techniques for testing of software deployment pipelines using prioritized test cases accelerate the feedback time for testing software code changes by automatically executing a set of prioritized test cases to evaluate an impact of one or more software file modifications. In this manner, software developers receive feedback from the testing process for the prioritized test cases more quickly, with a reduced resource usage, and testing delays are reduced. The testing of software deployment pipelines may comprise regression tests and/or end-to-end tests in at least some embodiments.

In some embodiments, a dual-mode testing approach is provided that leverages intelligent test case selection based on real-time code analysis. A static code analysis tool can identify impacted software code areas and a test mapping system may link the impacted software code changes to specific test cases, ensuring that the most relevant test cases are executed first in a relaxed testing mode and a subset of additional tests are executed in a comprehensive testing mode. This method, in some embodiments, accelerates the feedback loop while also optimizing resource usage and balancing thoroughness and speed to enhance an overall efficiency of the CI/CD pipeline.

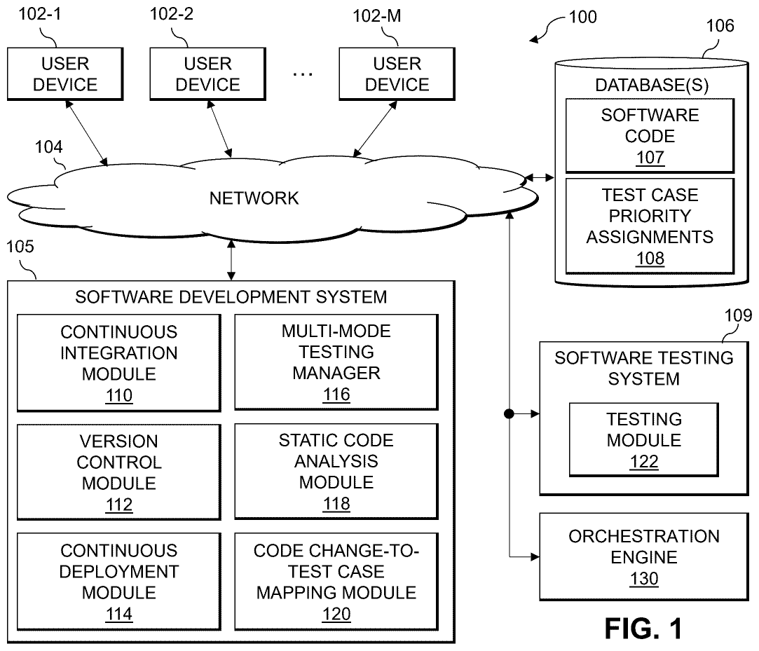

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 may be employed, for example, by software developers and other DevOps professionals to perform, for example, software development and/or software deployment tasks. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a software development system 105, a software testing system 109 and an orchestration engine 130.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The software development system 105 comprises a continuous integration module 110, a version control module 112, a continuous deployment module 114, a multi-mode testing manager 116, a static code analysis module 118 and a code change-to-test case mapping module 120. Exemplary processes utilizing elements 110, 112, 114, 116, 118 and/or 120 will be described in more detail with reference to, for example, the flow diagrams of FIGS. 2A, 2B, and 3 through 5.

In at least some embodiments, the continuous integration module 110, the version control module 112 and/or the continuous deployment module 114, or portions thereof, may be implemented using functionality provided, for example, by commercially available DevOps and/or CI/CD tools, such as the GitLab development platform, the GitHub development platform, the Azure DevOps server and/or the Bitbucket CI/CD tool, or another Git-based DevOps and/or CI/CD tool. The continuous integration module 110, the version control module 112 and the continuous deployment module 114 may be configured, for example, to perform CI/CD tasks and to provide access to DevOps tools and/or repositories. The continuous integration module 110 provides functionality for automating the integration of software code changes from multiple software developers or other DevOps professionals into a single software project.

In one or more embodiments, the version control module 112 manages canonical schemas (e.g., blueprints, job templates, and software scripts for jobs) and other aspects of the repository composition available from the DevOps and/or CI/CD tool. Source code management (SCM) techniques may be used to track modifications to a source code repository. In some embodiments, SCM techniques are employed to track a history of changes to a software code base and to resolve conflicts when merging updates from multiple software developers.

The continuous deployment module 114 manages the automatic release of software code changes made by one or more software developers from a software repository to a production environment, for example, after validating the stages of production have been completed. The continuous deployment module 114 may interact in some embodiments, with the software testing system 109 to coordinate the testing of software code and/or verify a successful testing of software code.

In at least some embodiments, the multi-mode testing manager 116 may implement at least portions of the disclosed techniques for testing of software deployment pipelines using prioritized test cases. For example, the multi-mode testing manager 116 may implement a comprehensive testing mode and a relaxed testing mode, as discussed further below. In one or more embodiments, the static code analysis module 118 may include functionality for analyzing software code changes and identifying one or more specific lines, functions, classes, or services that are affected by each commit operation.

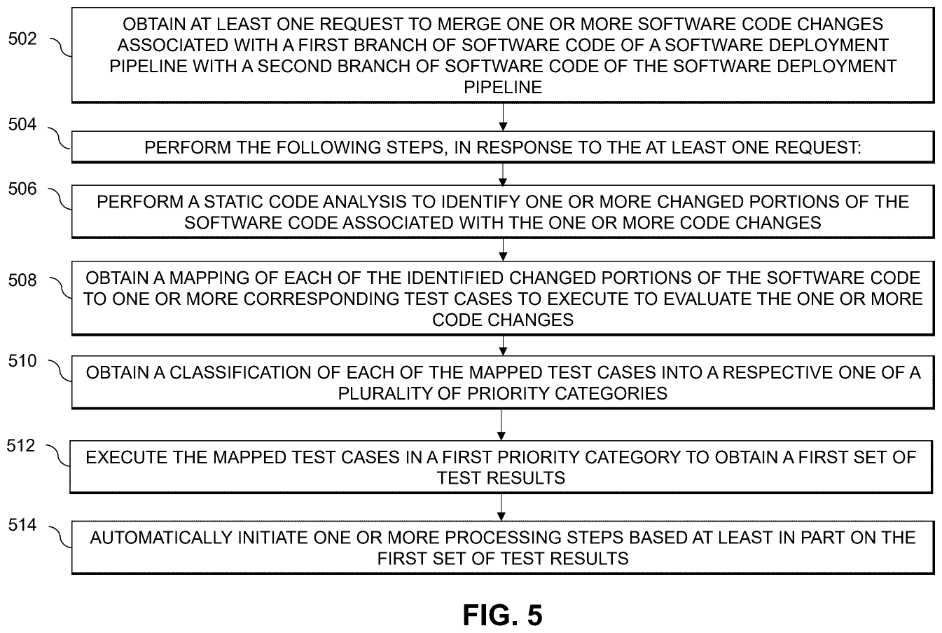

The code change-to-test case mapping module 120 may include functionality in some embodiments for linking software code changes to specific test cases that should be executed to evaluate such software code changes, as discussed further below in conjunction with FIGS. 4 and 5, for example.

It is to be appreciated that this particular arrangement of elements 110, 112, 114, 116, 118 and/or 120 illustrated in the software development system 105 of the FIG. 1 embodiment is presented by way of example only, and alternative arrangements can be used in other embodiments. For example, the functionality associated with the elements 110, 112, 114, 116, 118 and/or 120 in other embodiments can be combined into a single module or separated across a larger number of modules. As another example, multiple distinct processors can be used to implement different ones of the elements 110, 112, 114, 116, 118 and/or 120 or portions thereof.

At least portions of elements 110, 112, 114, 116, 118 and/or 120 may be implemented at least in part in the form of software that is stored in memory and executed by a processor.

The software testing system 109 comprises a testing module 122 that performs one or more software tests within a software deployment pipeline, as would be apparent to a person of ordinary skill in the art. Generally, software testing aims to ensure that bugs and other software code errors are detected as soon as possible and are remedied before being exposed to end-users. In some embodiments, the software testing system 109 performs pipeline-level testing, for example, in a virtualized environment.

It is to be appreciated that this particular arrangement of the testing module 122 illustrated in the software testing system 109 of the FIG. 1 embodiment is presented by way of example only, and alternative arrangements can be used in other embodiments. For example, the functionality associated with testing module 122 in other embodiments can be separated across a larger number of modules and/or multiple distinct processors can be used to implement the functionality associated with testing module 122, or portions thereof.

In at least some embodiments, the orchestration engine 130 may be implemented, at least in part, using the functionality of Kubernetes or variants thereof.

In one or more embodiments, the orchestration engine 130 may create environments using containers that provide a form of operating system virtualization. One container might be used to run a small microservice or a software process, as well as larger applications. The container provides the necessary executables, binary code, libraries, and configuration files. In some embodiments, the orchestration engine 130 may employ a PKS cluster (e.g., an enterprise Kubernetes platform) that enables developers to provision, operate and/or manage enterprise-level Kubernetes clusters to execute a pipeline job. The Docker open-source containerization platform may be leveraged in some embodiments for building, deploying, and/or managing containerized applications. Docker enables developers to package applications into container-standardized executable components that combine application source code with operating system libraries and dependencies required to run that code in any environment.

The orchestration engine 130 may manage the overall CI/CD process, such as the execution of identified test cases, as described herein, and coordinate the interaction between different tools and systems within the pipeline. The orchestration engine 130 may adapt a workflow of the CI/CD pipeline according to the selected test mode, as described herein (e.g., either a comprehensive testing mode or a relaxed mode in one embodiment). The orchestration engine 130 may schedule and trigger test executions, monitor test execution progress and collect test results, ensuring that the testing process is carried out efficiently and effectively.

Additionally, the software development system 105 and/or the software testing system 109 can have at least one associated database 106 configured to store data pertaining to, for example, software code 107 of at least one application and test case priority assignments 108 (e.g., a mapping of each test case to a corresponding priority category). For example, the at least one associated database 106 may correspond to at least one code repository that stores the software code 107. In such an example, the at least one code repository may include different snapshots or versions of the software code 107, at least some of which can correspond to different branches of the software code 107 used for different development environments (e.g., one or more testing environments, one or more staging environments, and/or one or more production environments). While the software code 107 and the test case priority assignments 108 are shown as distinct databases in the example of FIG. 1 at least portions of the software code 107 and the test case priority assignments 108 may be stored in a single database, as would be apparent to a person of ordinary skill in the art.

Also, at least a portion of the one or more user devices 102 can also have at least one associated database (not explicitly shown in FIG. 1). As an example, such a database can maintain a particular branch of the software code 107 that is developed in a sandbox environment associated with a given one of the user devices 102. Any changes associated with that particular branch can then be sent and merged with branches of the software code 107 maintained in the at least one database 106, for example.

An example database 106, such as depicted in the present embodiment, can be implemented using one or more storage systems associated with the software development system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the software development system 105 are one or more input-output devices, which illustratively comprise keyboards, displays or other types of input-output devices in any combination. Such input-output devices can be used, for example, to support one or more user interfaces to the software development system 105, as well as to support communication between software development system 105 and other related systems and devices not explicitly shown.

Additionally, the software development system 105, the software testing system 109 and/or the orchestration engine 130 in the FIG. 1 embodiment are assumed to be implemented using at least one processing device. Each such processing device generally comprises at least one processor and an associated memory, and implements one or more functional modules for controlling certain features of the software development system 105, the software testing system 109 and/or the orchestration engine 130.

More particularly, the software development system 105, the software testing system 109 and/or the orchestration engine 130 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the software development system 105, the software testing system 109 and/or the orchestration engine 130 to communicate over the network 104 with the user devices 102, and illustratively comprises one or more conventional transceivers.

It is to be understood that the particular set of elements shown in FIG. 1 for software development system 105 and the software testing system 109 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the software development system 105, the software testing system 109 and database(s) 106 can be on and/or part of the same processing platform.

FIG. 2A shows an example of a software development lifecycle in an illustrative embodiment. A software development lifecycle is comprised of a number of stages 210 through 250. In the example of FIG. 2A, a software development stage 210 comprises generating (e.g., writing) the software code for a given application. A software testing stage 220 tests the application software code. A software release stage 230 comprises delivering the application software code to a repository. A software deployment stage 240 comprises deploying the application software code to a production environment. Finally, a validation and compliance stage 250 comprises the steps to validate a deployment, for example, based at least in part on the needs of a given organization. For example, image security scanning tools may be employed to ensure a quality of the deployed images by comparing them to known vulnerabilities, such as those known vulnerabilities in a catalog of common vulnerabilities and exposures (CVEs).

FIG. 2B shows an example of one or more pipeline jobs in various pipeline stages 270-A through 270-N (collectively, pipeline stages 270) of a software deployment pipeline 260 in an illustrative embodiment. The pipeline stages 270-A through 270-N of a software deployment pipeline 260 may correspond, for example, to the stages 210, 220, 230, 240 and 250 of the software development lifecycle of FIG. 2A.

In the example of FIG. 2B, each pipeline stage 270 is comprised of a plurality of pipeline jobs, such as pipeline jobs A.1 and A.2 for pipeline stage 270-A. Each pipeline job is comprised of one or more steps (e.g., tasks, scripts and/or a reference to an external template), such as steps A.1.1 and A.1.2 of pipeline job A.1 and steps A.2.1 and A.2.2 of pipeline job A.2.

In one or more embodiments, a pipeline can comprise one or more of the following elements: (i) local development environments (e.g., the computers of individual developers); (ii) a CI server (or a development server); (iii) one or more test servers (e.g., for functional user interface testing of the product); and (iv) a production environment. The pipelines may be defined, for example, in YAML (Yet Another Markup Language) with a set of commands executed in series to perform the necessary activities (e.g., the steps of each pipeline job).

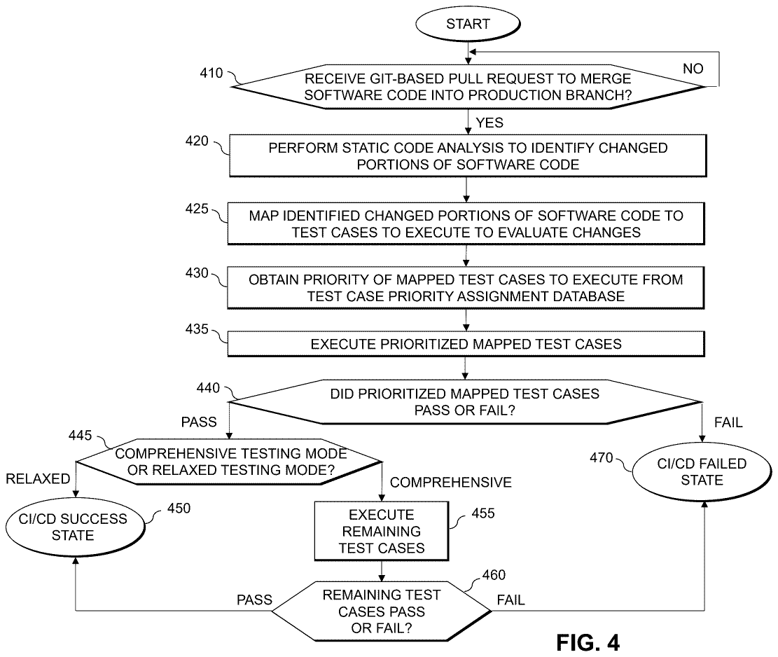

FIG. 3 illustrates a software development system 300 configured for testing of software deployment pipelines using prioritized test cases, in accordance with an illustrative embodiment. In the example of FIG. 3, the software development system 300 comprises a graphical user interface (GUI) 310 and a CI/CD pipeline engine 340.

In addition, in at least some embodiments, a user employing a user device 305 utilizes the GUI 310 to interact with the software development system 300, such as one or more visual representations of a software deployment pipeline or components thereof (e.g., pipeline jobs). Generally, the GUI 310 provides access to a visual software deployment pipeline editor, a pipeline manager, a DevOps toolkit and a reusable CI/CD resource library, for example.

As shown in FIG. 3, the exemplary CI/CD pipeline engine 340 comprises a YAML parser 345, an include parser 350, an anchor parser 355 and an extend parser 360. The YAML parser 345 processes top-level YAML files obtained from one or more DevOps collaboration tools, for example, for conversion into a renderable format, such as a JSON (JavaScript Object Notation) file format. The include parser 350 processes files referenced in include statements in the YAML file (e.g., whereby a first YAML file calls a second YAML file). The anchor parser 355 processes references in the YAML file, such as variables, images and other configuration items. The extend parser 360 is employed when an include statement specifies a defined job that a user would like to extend (e.g., to extend or otherwise customize a preconfigured job defined, for example, in a blueprint).

In the example of FIG. 3, the GUI 310 interacts with the exemplary CI/CD pipeline engine 340 and the orchestration engine 320, and the exemplary CI/CD pipeline engine 340 and the orchestration engine 320 also interact with one another, in order to automatically resolve one or more pipeline failures.

FIG. 4 is a flow chart illustrating an exemplary implementation of a process for testing of software deployment pipelines using prioritized test cases, in accordance with an illustrative embodiment. In the example of FIG. 4, a test is performed in step 410 to determine if a GIT-based pull request is received to merge software code into a production branch. If it is determined in step 410 that a GIT-based pull request is not received, then program control returns to step 410 to continue monitoring for a GIT-based pull request.

Once it is determined in step 410 that a GIT-based pull request is received, then a static code analysis is performed in step 420 to identify the changed portions of the software code. The static code analysis may identify one or more changed portions and dependencies of the software code and trace the software code change effects across a plurality of modules of the software code. The static code analysis tool (e.g., static code analysis module 118) may analyze code changes and identify the specific lines, functions, classes, or services affected by each commit operation, for example. The static code analysis tool may scan the entire codebase, detect modifications and generate a report highlighting the impacted areas.

In one or more embodiments, the static code analysis tool can be integrated with GIT-based version control tools that allow the static code analysis tool to continuously monitor software code changes and ensure that the test results are up to date. The output from the static code analysis tool may identify changed code portions (e.g., using line numbers).

In step 425, the changed portions of the software code identified in step 420 are mapped to particular test cases to execute to evaluate the identified changes. The mapping may be performed, for example, by the code change-to-test case mapping module 120. The code change-to-test case mapping module 120 may map the identified changed portions of the software code to one or more corresponding test cases by dynamically selecting the mapped test cases. In this manner, the code change-to-test case mapping module 120 links code changes to specific tests by maintaining a comprehensive mapping of which lines of code are covered by which test cases, functioning in a similar manner as a code coverage tool with a focus on mapping specific tests to particular code areas.

In one or more embodiments, the code change-to-test case mapping module 120 utilizes historical test execution data and code coverage reports to generate and continually update the mapping, ensuring that the mapping reflects the current state of the codebase. The test mapping identifies the tests relevant to the impacted code areas, allowing for identification of tests that need to be prioritized or selectively run, thereby ensuring that the tests most likely to be affected by recent software code changes are executed, enhancing the efficiency and effectiveness of the testing process.

In some embodiments, the mapping of the portions of the software code to particular test cases that need to be executed may be at least partially generated manually during code development (noting the functions that are covered by particular test cases). In addition, as noted above, static code analysis can monitor which code lines and/or functions are executed when particular test cases are executed (e.g., which lines of code, or which code functions, were covered by particular test cases during execution of the test cases to learn a mapping of lines/areas of code to test cases).

In step 430, a priority of the mapped test cases is obtained, for example, from the test case priority assignments 108 of FIG. 1. The priority of the mapped test cases may be obtained using a predefined priority test case listing. In some embodiments, at least portions of the prioritization of the mapped test cases may be dynamically generated over time by determining the important test cases to execute for the changes associated with each commit operation. For example, the priority of the mapped test cases may dynamically identify one or more test cases in a prioritized test case category based at least in part on the one or more changed portions of the software code associated with a given commit operation.

The prioritized mapped test cases are executed in step 435, ensuring that any immediate issues are caught as soon as possible, and the job can fail as soon as possible, if appropriate. By running the most relevant, prioritized tests first, feedback can be provided more quickly, allowing developers to address critical issues sooner.

A test is performed in step 440 to determine if the prioritized mapped test cases passed or failed. Once the prioritized tests pass, the CI/CD orchestrator may execute the remaining test cases to ensure comprehensive coverage (e.g., that the entire codebase is adequately covered, maintaining high software quality), as discussed below. One or more aspects of the disclosure recognize that early detection of issues with respect to the prioritized mapped test cases (e.g., in the most critical areas) reduces the likelihood of integration problems and ensures that major bugs are identified and resolved promptly.

Thus, if it is determined in step 440 that the prioritized mapped test cases passed, then a further test is performed in step 445 to determine if the CI/CD system (or a given project or repository, for example) is in a comprehensive testing mode or a relaxed testing mode. In some embodiments, a default setting may be that all projects, for example, are tested in a relaxed testing mode. If it is determined in step 445 that the CI/CD system (or the given project or repository, for example) is in a relaxed testing mode, then the CI/CD system is placed in a success state 450 without performing the remaining test cases that were not executed in step 435. In some embodiments, in a relaxed mode, the CI/CD orchestrator runs only the subset of prioritized test cases in step 435 directly related to the code changes, as identified by the test mapping and classification of steps 425 and 430. In this manner, the testing time is significantly reduced, providing faster feedback to developers, enabling quicker development iterations and reducing overall development time. By focusing only on the most relevant prioritized test cases, the testing process is expedited, reducing the use of computational resources and the time developers spend waiting for results. However, by running only a subset of test cases, there is still a minor chance of missing a code defect that could have been introduced by the software code changes.

If it is determined in step 445 that the CI/CD system (or the given project or repository, for example) is in a comprehensive testing mode, then the remaining test cases are executed in step 455. In the comprehensive testing mode, in some embodiments, the CI/CD orchestrator runs the remaining tests that were not executed in step 435 according to the test prioritization of step 430.

A test is performed in step 460 to determine if the remaining test cases (e.g., those test cases that were not executed in step 435) pass or fail. If it is determined in step 460 that the remaining test cases passed, then the CI/CD system is placed in the success state 450. If, however, it is determined in step 460 that the remaining test cases failed, then the CI/CD system is placed in a failed state 470.

If it is determined in step 440 that the prioritized mapped test cases passed, then the CI/CD system is placed in a failed state 470.

FIG. 5 is a flow chart illustrating an exemplary implementation of a process for testing of software deployment pipelines using prioritized test cases, in accordance with an illustrative embodiment. In the example of FIG. 5, at least one request to merge one or more software code changes associated with a first branch of software code of a software deployment pipeline with a second branch of software code of the software deployment pipeline is obtained in step 502. The following steps are performed in step 504, in response to the at least one request. A static code analysis is performed in step 506 to identify one or more changed portions of the software code associated with the one or more software code changes.

A mapping of each of the identified changed portions of the software code to one or more corresponding test cases to execute to evaluate the one or more software code changes is obtained in step 508. A classification of each of the mapped test cases into a respective one of a plurality of priority categories is obtained in step 510.

The mapped test cases in a first priority category are executed in step 512 to obtain a first set of test results. One or more processing steps are automatically initiated in step 514 based at least in part on the first set of test results.

In one or more embodiments, the mapping the identified changed portions of the software code to the one or more corresponding test cases dynamically selects the mapped test cases. mapping of each of the identified changed portions of the software code to the one or more corresponding test cases may be based on one or more of historical text execution data and at least one code coverage report. The static code analysis may identify one or more changed portions of the software code across a plurality of modules of the software code. The classification of the mapped test cases into the respective one of the plurality of priority categories may dynamically identify one or more test cases in the first priority category based at least in part on at least one of the one or more changed portions of the software code.

In at least one embodiment, the one or more processing steps comprise at least one of generating a notification related to the first set of test results; executing at least one additional test case based at least in part on the first set of test results; and causing an action, related to the first set of test results, to be performed in another system.

In some embodiments, the method may further comprise executing, in response to the software deployment pipeline being in a designated one of a plurality of testing modes, one or more additional mapped test cases in at least a second priority category to obtain a second set of test results. The executing the mapped test cases in the first priority category to obtain the first set of test results may occur in a relaxed testing mode and wherein the designated testing mode comprises a comprehensive testing mode. The software deployment pipeline may be configured into a given one of the plurality of testing modes by a system administrator. The system administrator can choose between the testing modes according to preferences of the organization, balancing speed and thoroughness to suit different stages of the development cycle, for example.

The particular processing operations and other network functionality described in conjunction with the flow diagrams of FIGS. 3 through 5, for example, are presented by way of illustrative example only, and should not be construed as limiting the scope of the disclosure in any way. Alternative embodiments can use other types of processing operations to provide functionality for testing of software deployment pipelines using prioritized test cases. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

In one or more embodiments, the disclosed techniques for prioritized software deployment testing provide a flexible and iterative approach to software testing that can reduce software development times and the use of computational resources, while also reducing the risk of missed software defects, ultimately contributing to more efficient and effective software delivery. A CI/CD framework is disclosed that provides faster, more relevant feedback in order to maintain high software development velocity and quality. By implementing the disclosed dual-mode testing approach, development teams can tailor their testing strategy to their current needs, balancing speed and thoroughness to suit different stages of the development cycle.

It should also be understood that the disclosed techniques for testing of software deployment pipelines using prioritized test cases can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for prioritized software deployment pipeline testing may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based prioritized software deployment pipeline testing engine, or portions thereof, are illustratively implemented for use by tenants of such a multi-tenant environment.

Cloud infrastructure as disclosed herein can include cloud-based systems. Virtual machines provided in such systems can be used to implement at least portions of a prioritized software deployment pipeline testing platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

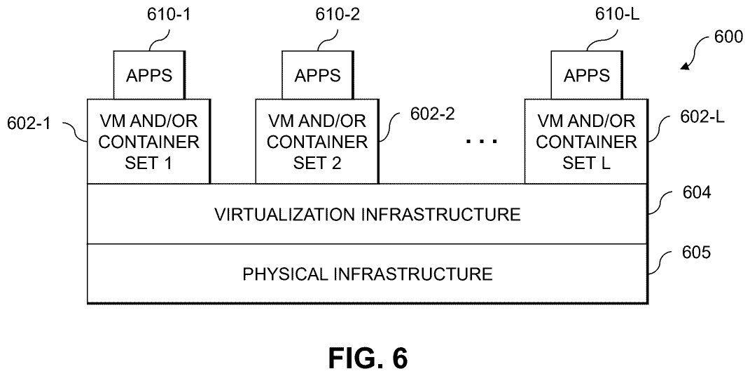

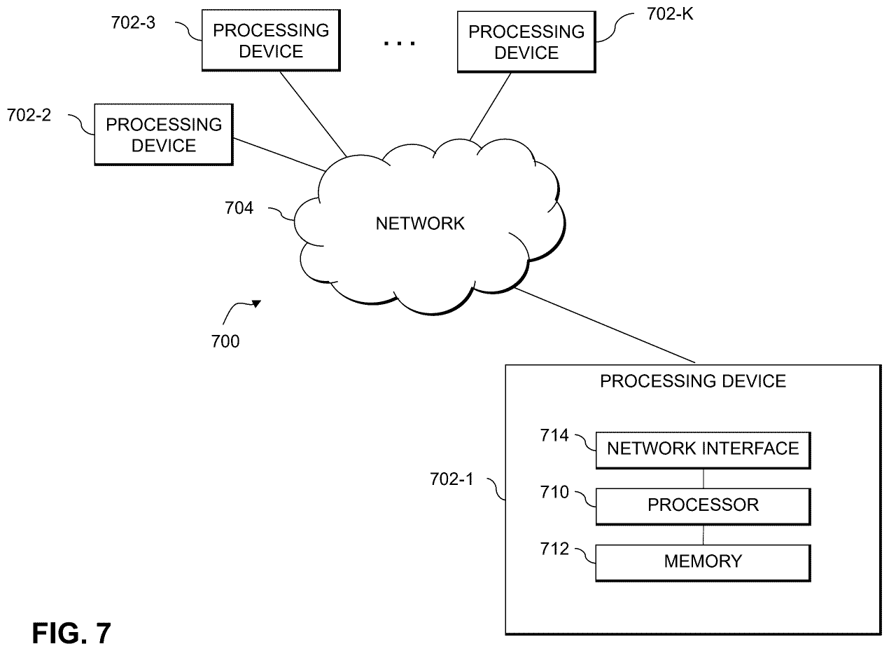

Illustrative embodiments of processing platforms will now be described in greater detail with reference to FIGS. 6 and 7. These platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple VMs and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2,. 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide prioritized software deployment pipeline testing functionality of the type described above for one or more processes running on a given one of the VMs. For example, each of the VMs can implement prioritized software deployment pipeline testing control logic and associated test result monitoring functionality for one or more processes running on that particular VM.

The hypervisor platform may have an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can provide prioritized software deployment pipeline testing functionality of the type described above for one or more processes running on different ones of the containers. For example, a container host device supporting multiple containers of one or more container sets can implement one or more instances of prioritized software deployment pipeline testing control logic and associated test result monitoring functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises at least a portion of the given system and includes a plurality of processing devices, denoted 702-1, 702-2, 702-3, . . . 702-K, which communicate with one another over a network 704. The network 704 may comprise any type of network, such as a WAN, a LAN, a satellite network, a telephone or cable network, a cellular network, a wireless network such as WiFi or WiMAX, or various portions or combinations of these and other types of networks.

The processing device 702-1 in the processing platform 700 comprises a processor 710 coupled to a memory 712. The processor 710 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 6 or 7, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining at least one request to merge one or more software code changes associated with a first branch of software code of a software deployment pipeline with a second branch of software code of the software deployment pipeline;
performing the following steps, in response to the at least one request:
performing a static code analysis to identify one or more changed portions of the software code associated with the one or more software code changes;
obtaining a mapping of each of the identified changed portions of the software code to one or more corresponding test cases to execute to evaluate the one or more software code changes;
obtaining a classification of each of the mapped test cases into a respective one of a plurality of priority categories;
executing the mapped test cases in a first priority category to obtain a first set of test results; and
automatically initiating one or more processing steps based at least in part on the first set of test results;
wherein the method is performed by at least one processing device comprising a processor coupled to a memory.

2. The method of claim 1, wherein the mapping of each of the identified changed portions of the software code to the one or more corresponding test cases dynamically selects the mapped test cases.

3. The method of claim 1, wherein the static code analysis identifies one or more changed portions of the software code across a plurality of modules of the software code.

4. The method of claim 1, wherein the mapping of each of the identified changed portions of the software code to the one or more corresponding test cases is based at least in part on one or more of historical text execution data and at least one code coverage report.

5. The method of claim 1, wherein the one or more processing steps comprise at least one of generating a notification related to the first set of test results; executing at least one additional test case based at least in part on the first set of test results; and causing an action, related to the first set of test results, to be performed in another system.

6. The method of claim 1, further comprising executing, in response to the software deployment pipeline being in a designated one of a plurality of testing modes, one or more additional mapped test cases in at least a second priority category to obtain a second set of test results.

7. The method of claim 6, wherein the executing the mapped test cases in the first priority category to obtain the first set of test results occurs in a relaxed testing mode and wherein the designated testing mode comprises a comprehensive testing mode.

8. The method of claim 6, wherein the software deployment pipeline is configured into a given one of the plurality of testing modes by a system administrator.

9. The method of claim 1, wherein the classification of the mapped test cases into the respective one of the plurality of priority categories dynamically identifies one or more test cases in the first priority category based at least in part on at least one of the one or more changed portions of the software code.

10. An apparatus comprising:
at least one processing device comprising a processor coupled to a memory;
the at least one processing device being configured to implement the following steps:
obtaining at least one request to merge one or more software code changes associated with a first branch of software code of a software deployment pipeline with a second branch of software code of the software deployment pipeline;
performing the following steps, in response to the at least one request:
performing a static code analysis to identify one or more changed portions of the software code associated with the one or more software code changes;
obtaining a mapping of each of the identified changed portions of the software code to one or more corresponding test cases to execute to evaluate the one or more software code changes;
obtaining a classification of each of the mapped test cases into a respective one of a plurality of priority categories;
executing the mapped test cases in a first priority category to obtain a first set of test results; and
automatically initiating one or more processing steps based at least in part on the first set of test results.

11. The apparatus of claim 10, wherein the mapping of each of the identified changed portions of the software code to the one or more corresponding test cases is based at least in part on one or more of historical text execution data and at least one code coverage report.

12. The apparatus of claim 10, wherein the one or more processing steps comprise at least one of generating a notification related to the first set of test results; executing at least one additional test case based at least in part on the first set of test results; and causing an action, related to the first set of test results, to be performed in another system.

13. The apparatus of claim 10, further comprising executing, in response to the software deployment pipeline being in a designated one of a plurality of testing modes, one or more additional mapped test cases in at least a second priority category to obtain a second set of test results.

14. The apparatus of claim 13, wherein the executing the mapped test cases in the first priority category to obtain the first set of test results occurs in a relaxed testing mode and wherein the designated testing mode comprises a comprehensive testing mode.

15. The apparatus of claim 10, wherein the classification of the mapped test cases into the respective one of the plurality of priority categories dynamically identifies one or more test cases in the first priority category based at least in part on at least one of the one or more changed portions of the software code.

16. A non-transitory processor-readable storage medium having stored therein program code of one or more software programs, wherein the program code when executed by at least one processing device causes the at least one processing device to perform the following steps:
obtaining at least one request to merge one or more software code changes associated with a first branch of software code of a software deployment pipeline with a second branch of software code of the software deployment pipeline;
performing the following steps, in response to the at least one request:
performing a static code analysis to identify one or more changed portions of the software code associated with the one or more software code changes;
obtaining a mapping of each of the identified changed portions of the software code to one or more corresponding test cases to execute to evaluate the one or more software code changes;
obtaining a classification of each of the mapped test cases into a respective one of a plurality of priority categories;
executing the mapped test cases in a first priority category to obtain a first set of test results; and
automatically initiating one or more processing steps based at least in part on the first set of test results.

17. The non-transitory processor-readable storage medium of claim 16, wherein the mapping of each of the identified changed portions of the software code to the one or more corresponding test cases is based at least in part on one or more of historical text execution data and at least one code coverage report.

18. The non-transitory processor-readable storage medium of claim 16, wherein the one or more processing steps comprise at least one of generating a notification related to the first set of test results; executing at least one additional test case based at least in part on the first set of test results; and causing an action, related to the first set of test results, to be performed in another system.

19. The non-transitory processor-readable storage medium of claim 16, further comprising executing, in response to the software deployment pipeline being in a designated one of a plurality of testing modes, one or more additional mapped test cases in at least a second priority category to obtain a second set of test results, and wherein the executing the mapped test cases in the first priority category to obtain the first set of test results occurs in a relaxed testing mode and wherein the designated testing mode comprises a comprehensive testing mode.

20. The non-transitory processor-readable storage medium of claim 16, wherein the classification of the mapped test cases into the respective one of the plurality of priority categories dynamically identifies one or more test cases in the first priority category based at least in part on at least one of the one or more changed portions of the software code.
